(19) United States
(12) Patent Application Publication
(10) Pub. No.: US 2026/0004612 A1
(43) Pub. Date: Jan. 1, 2026

(54) ENROLLMENT, IDENTIFICATION, AND/OR VERIFICATION FOR A BIOMETRIC SECURITY SYSTEM

(71) Applicant: HID Global Corp., Austin, TX (US)

(72) Inventor: Daniel Henri Raguin, Jupiter, FL (US)

(21) Appl. No.: 18/867,934

(22) PCT Filed: Jun. 6, 2022
(86) PCT No.: PCT/US2022/072767

§ 371 Date: Nov. 21, 2024

(51) Int. Cl. G06V 40/50; G06V 10/74; G06V 40/12; G06V 40/13

(52) U.S. Cl. CPC G06V 40/50; G06V 10/74; G06V 40/1312; G06V 40/1318; G06V 40/1365

(57) ABSTRACT

Methods and systems for enrollment of a biometric presentation for a biometric security system and methods and systems for identification and/or verification of a probe biometric presentation based on an enrolled biometric presentation. An example method comprises: capturing and processing a plurality of images of the biometric presentation to produce a plurality of candidate images; forming a Gallery Set of gallery images from at least some of the plurality of candidate images based on a matching of the plurality of candidate images; and generating a Gallery Web from the Gallery Set, the Gallery Web comprising correlation data defining correlations between the gallery images of the Gallery Set.

### TECHNICAL FIELD

The present disclosure relates to improved systems and methods for enrollment, identification, and/or verification for a biometric security system.

### BACKGROUND

Fingerprint sensing is widely used for identification or verification purposes. For this, a person's fingerprint is acquired by a fingerprint scanning apparatus whose output is processed and compared with stored characteristic data of one or more enrolled fingerprints (also referred to herein as gallery images), stored for example in an enrollment database, to determine whether a match exists. Typically, when a person's fingerprint data is enrolled in a biometric identification (ID) or verification system, a single representation of each of one or more of the person's fingers is entered into the enrollment database. This works well with large area contact fingerprint scanners that have well-defined capture platen areas that are larger than the area of a typical person's finger. However, for non-contact fingerprint scanners or scanning systems (also referred to as contactless or touchless fingerprint scanners or scanning systems), for which the person's finger is not placed on such a well-defined capture platen, the finger is not mechanically constrained. As such, the person's fingerprint to be enrolled might not be fully within the scanner's field of view (FOV) or might be rotated such that more of one side of the fingerprint is seen as compared to another side of the fingerprint. A problem exists that when only a single enrollment or gallery image is captured to compare against a single verification or identification fingerprint image (also referred to herein as a test image or probe image), as is conventionally done, in the case of unconstrained, contactless fingerprint scanning systems, the enrollment or gallery image may be oriented differently from the test or probe image, resulting in a lower genuine match score than expected.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates a schematic diagram of an example contactless fingerprint scanning apparatus;

FIGS. 2a and 2b illustrate a subject's finger being presented to a contactless fingerprint scanning apparatus;

FIG. 3 is a flow diagram for an example method for capturing enrollment images for a biometric presentation;

FIG. 4 schematically and conceptually illustrates a Gallery Web;

FIG. 5 is a flow diagram for an example method for matching one or more probe images of a biometric presentation to a Gallery Set or Gallery Web;

FIG. 6a schematically and conceptually illustrates a Gallery Web;

FIG. 6b schematically and conceptually illustrates a set of gallery images from the Gallery Web of FIG. 6a;

FIG. 6c schematically and conceptually illustrates another set of gallery images from the Gallery Web of FIG. 6a; and

FIG. 7 illustrates a block diagram schematic of various example components that can be included as part of, or may be operably connected to, a biometric scanning apparatus.

### DETAILED DESCRIPTION

The present disclosure generally relates to improved systems and methods for enrollment, identification, and/or verification for a biometric security system. While described primarily with respect to unconstrained, contactless fingerprint scanning systems, and to systems incorporating the use of fingerprint data, the various embodiments of the present disclosure may similarly be applied to contact fingerprint scanning systems, where the finger is placed onto a physical platen surface, or to systems additionally or alternatively using other biometric modalities, such as but not limited to, facial recognition data, iris data, palm print data, etc. to, for example, increase matching performance.

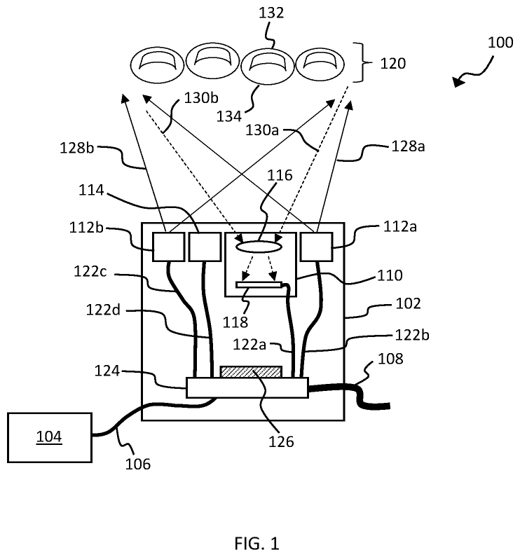

FIG. 1 schematically illustrates an example contactless fingerprint scanning apparatus 100 contained within a housing 102 and which may be connected to a processing device 104, such as a computer, microprocessor, or like device, via a communication and power cable 106. Although the processing device 104 is illustrated outside the housing 102 in FIG. 1, the processing device, or portions thereof, may alternatively be contained within the housing. The apparatus 100 may additionally or alternatively contain its own power supply or may receive power from a separate power cable 108. Within the housing 102, the apparatus 100 may include a camera module 110, one or more illumination modules 112a and 112b, and an optional proximity module 114. The camera module 110 may, in a simple form, include a housing containing an imaging module 116 and a sensor 118, such as a sensor printed circuit board (PCB). The imaging module 116 may include one of more lenses designed to image a biometric presentation 120, such as of one or more fingerprints, onto an electronic sensor, such as the sensor 118, where such lenses may be one or more of reflective, refractive, diffractive, or Fresnel designs. The sensor 118 may include an electronic sensor, which by way of example but not limitation, may be a pixelated charge-coupled device (CCD) or complementary metal oxide semiconductor (CMOS) device. The sensor 118 may further contain other electronic components to facility capture and potential processing of captured images, such as but not limited to, memory and/or one or more processors. The illumination modules 112a and 112b may include one or more light sources generally used for high-quality imaging of a biometric presentation (e.g., 120). Such light sources may include one or more light emitting diodes (LEDs) or diode arrays, due to their compact size, low-cost, and energy efficiency. However, other light sources, such as but not limited to, fluorescent lamps, lasers, or filaments may alternatively or additionally be used. The wavelength of the light source(s) chosen may change depending upon the biometric presentation of interest. For example, for fingerprint scanning it is often preferable to use blue or green light, while for iris scanning, it is often preferable to use near infrared (NIR) light. The proximity module 114 may be optionally present for such example applications as detecting that a biometric presentation (e.g., 120) has entered into the field of view of the apparatus 100 and waking up the sensor 118 from, for example, a sleep mode or determining a distance that the biometric presentation is from the camera module 110 to perform, for example, a rapid coarse focus of the imaging module 116. In an example, the imaging module incorporates some mechanism or means for autofocusing, such as but not limited to, a voice coil or piezo motor movement, use of liquid lenses, or other suitable form(s) of variable focus lenses. The camera module 110, illumination modules 112a and 112b, and proximity module 114 may be connected via power and communication cables 122a, 122b, 122c, and 122d, respectively, with a communication PCB 124. The communication PCB 124 may include one or more processors 126 and other electronic components, such as but not limited to, memory, for the control of the attached modules. The communication PCB 124 may provide the processor(s) 126 with power and memory to process images (for example, extracting and matching biometric data) that are collected. Alternatively or additionally, image processing may be performed at processing device 104.

As illustrated in FIG. 1, light rays, such as rays 128a and 128b (illustrated in solid line), from illumination modules 112a and 112b, may illuminate the biometric presentation 120 to assist in the capture of high-quality images. However, apparatus 100 may not use artificial illumination and may instead rely upon ambient illumination. Light rays, such as rays 130a and 130b (illustrated in broken line), represent the light returned from the biometric presentation 120, which are collected by the camera module 110 and imaged by the imaging module 116 onto the sensor 118. The biometric presentation 120 is illustrated in FIG. 1 as a set of four fingers 132 with corresponding fingerprints 134. However, the apparatus 100 or similar apparatus may be used to collect fingerprint data for any number of fingers, including less than four (such as one finger) or more than four. Additionally, the apparatus 100 or similar apparatus may be used to collect biometric data corresponding to other biometric modalities, such as but not limited to, facial recognition data, iris data, palm print data, etc.

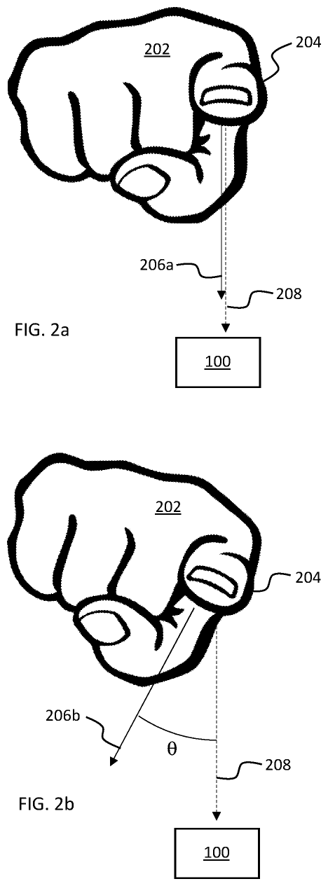

With respect to a particular example of fingerprint scanning with a contactless fingerprint scanning apparatus, such as the apparatus 100 illustrated in FIG. 1, a subject's hand 202 may in one instance, as illustrated in FIG. 2a, be positioned to allow the subject's finger 204 being scanned by the fingerprint scanning apparatus to have an orientation 206a (generally normal to a bottom surface of the finger) substantially aligned with a direction 208 at which the fingerprint scanning apparatus is capturing an image of said finger. However, since contactless fingerprint scanning apparatuses do not generally constrain the subject's hand or finger, a subject's hand may not be so properly positioned or oriented, as illustrated for example in FIG. 2b. In such an example instance, the same subject's hand 202 is rotated with respect to the fingerprint scanning apparatus 100, causing the subject's finger 204 to be correspondingly rotated, resulting in an orientation 206b (generally normal to a bottom surface of the finger) of the finger 204 having an angle θ relative to the direction 208 at which the fingerprint scanning apparatus is capturing an image of said finger. As a result, the images captured for the two different instances depicted in FIGS. 2a and 2b will have different views of the same finger 204 and, therefore, different matchable information captured. If, for example, a single image of the subject's finger at approximately the orientation illustrated in FIG. 2a is captured during enrollment and subsequently a single image of the subject's finger at some other orientation, such as the orientation illustrated in FIG. 2b, is captured as a probe image, then matching such probe image with the image captured during enrollment would be undesirably less than optimal since part of the subject's finger captured during enrollment would not be present in the probe image due to the rotation of the subject's finger. It is noted that although FIGS. 2a and 2b illustrate a single finger 204 being presented at a time to the fingerprint scanning apparatus 100, the present disclosure is not restricted to single-finger scanning apparatuses, but may be applied regardless of the number of fingers presented at a time. Additionally, similar issues arise in other types of contactless biometric scanning, such as facial or iris scanning.

In view of the foregoing, various embodiments of the present disclosure are generally directed to capturing a plurality of enrollment or gallery images of a biometric presentation, such as a fingerprint, during enrollment of a subject for a biometric security system, such as but not limited to a biometric ID or verification system. An objective is to capture a plurality of enrollment images such that each enrollment image contains some alternate or additional amount of information so that, collectively, a larger amount of matchable biometric information (as compared to capturing just a single enrollment image) is captured for a particular biometric presentation. The plurality of enrollment images do not need to be one hundred percent (100%) or nearly one hundred percent (100%) correlated, but rather may merely be different enough so that the quality or efficiency of future matching with probe images is increased. Various embodiments of the present disclosure can also include capturing a plurality of probe images of a biometric presentation during verification or identification to serve as a plurality of images for comparison to the plurality of enrollment or gallery images.

In general, in an example, described with respect to capturing enrollment images during enrollment of a subject's fingerprint with a contactless fingerprint scanning apparatus (e.g., 100), the subject may slowly tip, roll, or otherwise move around the subject's hand or finger (having the fingerprint), generally in pitch and yaw, in order to capture multiple enrollment images of the fingerprint at various pitches and/or yaws. The multiple enrollment images may be stitched together to create a more complete fingerprint or rolled fingerprint version of the subject's finger presented. In another example, the multiple enrollment images or metadata corresponding to each of the enrollment images may be additionally or alternatively stored separately. This process may be performed sequentially or simultaneously for each of a plurality of fingers of the subject's hand. Again, while described primarily with respect to capturing fingerprint data with a contactless fingerprint scanning apparatus, capturing fingerprint data may similarly be captured using a contact fingerprint scanning apparatus. Likewise, the same or similar method may additionally or alternatively be used to collect data relating to other biometric modalities, such as but not limited to, facial recognition data, iris data, palm print data, etc.

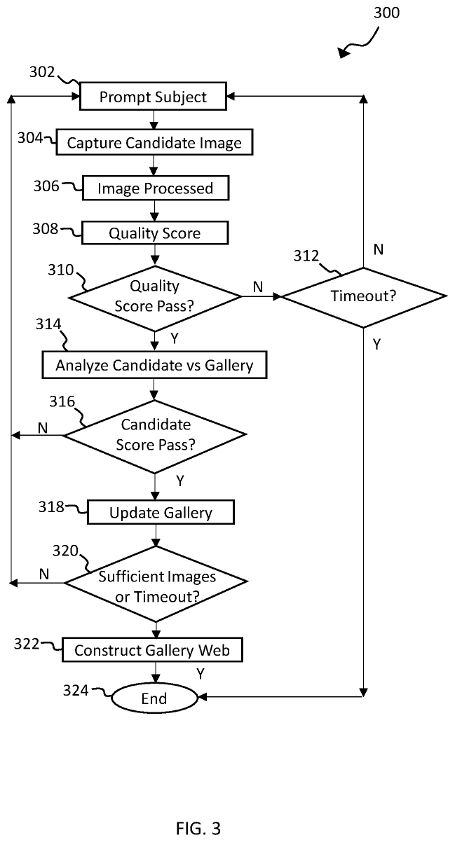

A more particular example method 300 for capturing enrollment images for a biometric presentation is illustrated in FIG. 3. As mentioned previously, while described primarily with respect to capturing fingerprint data with a contactless fingerprint scanning apparatus (e.g., 100), capturing fingerprint data may similarly be captured using a contact fingerprint scanning apparatus. Likewise, the same or similar method may additionally or alternatively be used to collect images and/or data relating to other biometric modalities, such as but not limited to, facial recognition data, iris data, palm print data, etc.

At step 302 of the method 300, a subject is prompted to begin scanning their finger(s) at a fingerprint scanning apparatus (e.g., 100). A prompt may be provided using any suitable output or feedback mechanism, such as but not limited to, visual, audio, and/or tactile (for example haptic) output or feedback, or combinations of suitable output or feedback mechanisms. The output or feedback mechanism may be provided by the fingerprint scanning apparatus 100 or may be provided by another device operably coupled or communicatively coupled with the fingerprint scanning apparatus. In an example, the subject may initially be prompted to begin scanning their finger(s) and may subsequently receive feedback regarding a preferred placement of the finger(s) and/or a preferred pitch or yaw of the finger(s) to, for example, capture multiple enrollment images that substantially or fully map a determined range of finger pitch and yaw angles. In some examples, the fingerprint scanning apparatus 100 may include one or more sensors, one or more detectors, or other means for determining the orientation of the subject's finger(s) or hand so that appropriate prompts may be provided via the output or feedback mechanism to the user to help ensure that images at several, or all desired, orientations of the subject's finger(s) are captured.

At step 304 of the method 300, a candidate image is captured by the fingerprint scanning apparatus 100. At step 306, the candidate image is processed. Image processing may include performing one or more of a multitude of image processing algorithms, such as segmentation. In an example, for biometric presentation of a finger or fingers, segmentation can include, but is not limited to, locating the fingertips of one or more fingers and extracting only that portion of the image to analyze. For biometric presentation of a face, segmentation can include masking the background around a face. For biometric presentation of an iris, segmentation can include locating one or more eyes in the image and extracting just the iris image data. Other image processing algorithms include, but are not limited to, noise reduction, histogram equalization, and contrast enhancement.

At step 308 of the method 300, after the candidate image is processed, an image or quality score may be calculated for the candidate image based upon one or more suitable metrics, such as but not limited to, focus quality, biometric capture area, and biometric presentation count. At step 310, the image score for the candidate image is compared to a certain (e.g., predefined or preset) quality threshold. If the image score for the candidate image does not meet or exceed the quality threshold, then if the image capturing process has not timed out for some reason, which may be determined at step 312, the method 300 returns to step 302 to prompt the subject to give another biometric presentation of their finger(s) and/or to reposition their finger(s). In another example, the method 300 returns directly to step 304 to capture a new candidate image without prompting the subject to give another biometric presentation of their finger(s) and/or to reposition their finger(s). At step 312, if it is determined that the image capturing process has timed out, then the method 300 proceeds to step 324 and ends. In another example, if it is determined at step 312 that the image capturing process has timed out, then the method 300 may proceed to step 322 (described below).

On the other hand, if at step 310 the candidate image meets or exceeds the quality threshold, then at step 314, the candidate image is analyzed against other images already captured during the method 300 for the subject. If at step 314 it is determined that the candidate image is the first image captured for the subject during the method 300, the candidate image is considered a valid enrollment image and the determination at step 316 (described below) may be bypassed and the (first) candidate image and/or metadata corresponding to the (first) candidate image may be added as the first image and/or corresponding metadata to a Gallery Set for the subject at step 318. Metadata for an image may comprise any suitable or useful information about the image, such as any information obtained during image processing at step 306 or any other information that may be extracted from the image, such as but not limited to, biometric template data. The Gallery Set represents the enrollment data for the subject upon which future verifications or identifications of the subject will be based.

If at step 314 it is determined that the candidate image is not the first image captured for the subject during the method 300, then the candidate image (and/or corresponding metadata) is analyzed relative to the Gallery Set. In an example of an analysis that may be performed at step 314, in general, the candidate image (and/or corresponding metadata) is matched or compared to images (and/or corresponding metadata) in the Gallery Set. The matching may be performed with respect to each of the gallery images of the Gallery Set, or based upon a “web” representation of the Gallery Set (explained in detail below), a selected subset of the Gallery Set may be matched or compared to the candidate image (and/or corresponding metadata). In an example, matching between images, such as the candidate image and a gallery image, may be performed in a traditional manner by deriving or extracting a biometric template (e.g., metadata) from each of the images and performing a comparison, or match, on the template/metadata derived from the images. Example biometric extracting and matching software packages are commercially available from companies such as, but not limited to, Neurotechnology (based in Lithuania) and Innovatrics (based in Slovakia). In another example, matching between images, such as the candidate image and a gallery image, may be performed by mapping the position of landmarks in each of the images and comparing, or matching, the positions of the landmarks. However, any suitable method for matching between images may be used. For each match between images (and/or corresponding metadata), such as the candidate image (and/or corresponding metadata) and a gallery image (and/or corresponding metadata), a match score or other suitable metric is generated.

At step 316, it is determined whether the candidate image (and/or corresponding metadata) should be added to the Gallery Set based on the analysis at step 314. In an example, if all match scores determined at step 314 between the candidate image (and/or corresponding metadata) and images (and/or corresponding metadata) from the Gallery Set are less than or equal to a certain (e.g., predefined or preset) maximum match threshold, MaxMatchThreshold, it is determined that the candidate image (and/or corresponding metadata) would add sufficiently more biometric information to the Gallery Set and should be added to the Gallery Set.

In an example, at step 316, if any match score is greater than the MaxMatchThreshold, this indicates that the candidate image (and/or corresponding metadata) is very similar to an image (and/or corresponding metadata) of the Gallery Set. Thus, the candidate image may not add significantly or sufficiently more biometric information to the Gallery Set. At step 316, therefore, a decision may be made as to whether the candidate image (and/or corresponding metadata) should be discarded or the matching image (and/or corresponding metadata) from the Gallery Set should be replaced by the candidate image. This decision may be based upon any suitable factors, such as but not limited to, a quality score for each of the candidate image and the matching image based on, for example, focus, number of biometric features (e.g., minutiae for the case of fingerprints), and/or capture area. However, any method may be used to determine whether the candidate image (and/or corresponding metadata) should be discarded or the matching image (and/or corresponding metadata) from the Gallery Set should be replaced by the candidate image.

In a further example, at step 316, it may additionally be determined whether any match score determined at step 314 between the candidate image (and/or corresponding metadata) and images (and/or corresponding metadata) from the Gallery Set is less than a certain (e.g., predefined or preset) minimum match threshold, MinMatchThreshold. Such a determination can be used to check whether the candidate image would potentially be adding too much new information about the subject's biometric presentation to the Gallery Set. Using a fingerprint as an example, the candidate image may comprise an image in which the subject's finger is over-rotated and too much of the subject's nail is captured in the image. Determining that one or more match scores determined at step 314 between the candidate image (and/or corresponding metadata) and images (and/or corresponding metadata) from the Gallery Set are less than the MinMatchThreshold may indicate potential issues with the candidate image, such as but not limited to, a potential issue with quality that may have been missed at Steps 308 and 310 (e.g., too much motion blur), occurrence of a potential sequence error (e.g., subject swapped fingers either by accident or on purpose), etc. At step 316, in an example, if the number of match scores determined at step 314 that are less than the MinMatchThreshold exceeds a certain (e.g., predefined or preset) threshold, Nₘᵢₙ, then the candidate image (and/or corresponding metadata) may be discarded and the method 300 may return to step 302 to prompt the subject to give another biometric presentation of their finger(s) and/or to reposition their finger(s). In a particular example, the candidate image (and/or corresponding metadata) may be discarded and the method 300 may return to step 302 to prompt the subject to give another biometric presentation of their finger(s) and/or to reposition their finger(s) when all the match scores determined at step 314 are less than the MinMatchThreshold. In an alternative example, it may be determined that the candidate image (having one or more match scores below the MinMatchThreshold) should nonetheless be added to the Gallery Set, and information relating to the candidate image may be used to prompt the subject, for example, when the method 300 returns to step 302, to present the subject's biometric presentation (e.g., fingerprint(s)) in such a way to generate images to fill gaps between such candidate image and the rest of the Gallery Set.

If at step 316, it is determined either that the candidate image (and/or corresponding metadata) should be added to the Gallery Set or that the matching image (and/or corresponding metadata) from the Gallery Set should be replaced by the candidate image, then at step 318, the Gallery Set is updated to include the candidate image (and/or corresponding metadata). Otherwise, the method 300 returns to step 302 to prompt the subject to give another biometric presentation of their finger(s) and/or to reposition their finger(s). In an example, the prompt at step 302 (e.g., visual, audio, and/or tactile feedback) may inform the subject as to how to desirably change the subject's biometric presentation (e.g., pitch and/or yaw of the biometric presentation). If appropriate, at step 318, the matching image (and/or corresponding metadata) being replaced by the candidate image may be deleted from the Gallery Set.

At step 320, it is determined whether the number of images (and/or corresponding metadata) in the Gallery Set, N_{g}, meets or exceeds a maximum number, Nₘₐₓ. If it is determined at step 320 that N_{g} does not meet or exceed Nₘₐₓ, then if the image capturing process has not timed out for some reason, the method 300 returns to step 302 to prompt the subject to give another biometric presentation of their finger(s) and/or to reposition their finger(s). In an example, the prompt at step 302 (e.g., visual, audio, and/or tactile feedback) may inform the subject as to how to desirably change the subject's biometric presentation (e.g., pitch and/or yaw of the biometric presentation).

If it is determined at step 320 that N_{g} meets or exceeds Nₘₐₓ or the image capturing process has timed out for some reason, then the method 300 proceeds to step 324 and ends.

The method 300 may optionally include an additional step 322 subsequent step 320 for constructing a Gallery “Web.” Alternatively, step 322 could be performed as a separate method after the method 300 (i.e., after step 324). In an example, in step 322, each of the N_{g} gallery images (and/or corresponding metadata) of the Gallery Set may be compared against the other gallery images (and/or corresponding metadata) of the Gallery Set. The number of match scores generated will, therefore, be N_{g}*(N_{g}−1)/2. In an example, each match pair, or a subset of all match pairs, and corresponding match scores may be stored in memory. It can then be determined whether the match score for any two gallery images of the Gallery Set is greater than a certain (e.g., predefined or preset) threshold, which may be the same as the MaxMatchThreshold or may be a different threshold. If it is determined that a match score for two gallery images of the Gallery Set is greater than the threshold, one of the two gallery images (and/or corresponding metadata) can be deleted from the Gallery Set. Any suitable method for determining which of the two gallery images to delete can be used. In an example, the gallery image with a lower corresponding quality score (e.g., the quality score determined at step 310) may be deleted. In a further example, any gallery image (and/or corresponding metadata) for which all its match scores with the other gallery images (and/or corresponding metadata) is less than a certain (e.g., predefined or preset) threshold, which may be the same as the MinMatchThreshold or may be a different threshold, may be deleted from the Gallery Set or may be retained in the Gallery Set and assigned a lower confidence score (discussed in further detail below), to generally represent it as being an outlier as compared to other gallery images in the Gallery Set.

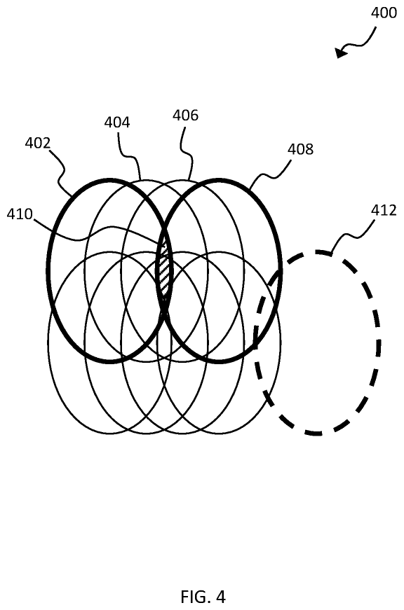

The Gallery Web may then be determined or constructed based upon the match scores for each gallery image (and/or corresponding metadata) to the other gallery images (and/or corresponding metadata) in the Gallery Set. Determining or constructing a Gallery Web may be understood with reference to FIG. 4, which schematically and conceptually illustrates a Gallery Web 400. In FIG. 4, the Gallery Web 400 conceptually illustrates how gallery images of the Gallery Set, for example gallery images 402, 404, 406, and 408, are more or less correlated with each other.

In an example, each of the gallery images (e.g., 402, 404, 406, 408) is arranged (e.g., assigned a position) in the Gallery Web 400 according to coordinates that correspond to the spatial region of the biometric presentation for which that image contains information or to which that image pertains. In such an example, the Gallery Web 400 may essentially be considered a map that illustrates which spatial locations have image data associated therewith and which do not. Hardware and/or software can be provided, for example in apparatus 100, for determining how captured images (e.g., gallery images) map to spatial regions of the biometric presentation. For example, scanners that incorporate structured light, time of flight, or stereoscopic vision for scanning biometric presentations, such as but not limited to, fingers, faces, or irises, may be provided to capture a 3-dimensional (3D) point cloud of the biometric presentation from which positional information of the biometric presentation may be extracted. Additionally or alternatively, the position of each captured image (e.g., gallery image) may be determined by features that are identified within each captured image, some of which are shared by one or more other captured images, and therefore a spatial positioning or overlapping between the captured images may be recognized or determined. In an example, the Gallery Web 400 may be stored in memory such that position data is assigned to each gallery image. The position data may include, for example but not limited to, x, y, z spatial coordinates and/or other or additional coordinate data. The position of a given gallery image (and/or corresponding metadata) in the Gallery Web 400 relative to other gallery images (and/or corresponding metadata) may be determined based on, for example, calculation of the Euclidian distance between the images using the corresponding assigned position data. Considering FIG. 4 as a conceptual representation of the physical area of a biometric presentation captured collectively by the gallery images (e.g., 402, 404, 406, 408) of the Gallery Web 400, then the ellipses surrounding each of the gallery images conceptually illustrate a respective spatial perimeter within which biometric data was captured for the respective gallery image. Although each of the gallery images (e.g., 402, 404, 406, 408) of the Gallery Web 400 is conceptually illustrated in FIG. 4 as an ellipse, in general, the actual spatial perimeter corresponding to each gallery image can be any other closed loop shape that contours the area of the biometric presentation (e.g., fingerprint(s)) that was collected.

In another example, the match scores between the various gallery images (and/or corresponding metadata) or other correlation score or data may be used to determine or assign a relative position for each of the gallery images to construct the Gallery Web 400. In an example, a pseudo distance between each of the gallery images (and/or corresponding metadata) may additionally be determined from the match scores and may additionally or alternatively be used to determine or assign a relative position for each of the gallery images. A non-limiting example equation for determining a pseudo distance between two images (and/or corresponding metadata) can be defined as Equation (1) below:

$$Pseudo\_Distance = Max\_MatchScore / matchscore - 1 , \qquad ( 1 )$$

where matchscore is the match score between the two images and Max_MatchScore is the maximum value the match score may be. For example, if a match score may range from 0 to 100, then Max_MatchScore will be 100. If the Pseudo_Distance is nearer to 0, there is a higher correlation between the two images (and/or corresponding metadata). On the other hand, if the Pseudo_Distance is relatively large, the two images (and/or corresponding metadata) may be fairly uncorrelated. In examples where the algorithm used to calculate the match score between two images allows for the matchscore to equal zero (0), a constant may be added to the matchscore in Eq. (1) so that the denominator will not be zero but an objective that the Pseudo_Distance is a relatively small number for highly correlated images and relatively large for fairly uncorrelated images is retained.

At any rate, in an example in which match scores between the various gallery images (and/or corresponding metadata) or other correlation scores or data, such as pseudo distances, are used to determine or assign a relative position for each of the gallery images to construct the Gallery Web 400, for a given gallery image (e.g., 402, 404, 406, 408), its nearest neighbors will generally correspond to the other gallery images that have the most overlap of spatial information for a given biometric presentation, and these images would generate higher match scores. Other gallery images that contain biometric information from a portion of the biometric presentation that are more spatially shifted from the given gallery image would have a lower match score. In general, a conceptual web may be constructed by analyzing or examining the match scores or other correlation score or data, such as pseudo distances, determined for each gallery image (and/or corresponding metadata) against the other gallery images (and/or corresponding metadata) in the Gallery Set. In this example, the positions of the gallery images (e.g., 402, 404, 406, 408) in FIG. 4 may be conceptually similar to the positions of circles in a Venn Diagram. As such, the ellipses surrounding each of the gallery images in FIG. 4 may not represent a spatial mapping of the position of the gallery images (e.g., 402, 404, 406, 408), but rather an illustration of the matching correlations between the gallery images. Although each of the gallery images (e.g., 402, 404, 406, 408) of the Gallery Web 400 is conceptually illustrated in FIG. 4 as an ellipse, the conceptual representation is only a tool by which to explain various embodiments of the present disclosure. Also, the conceptual representation of the Gallery Web 400 is not intended to illustrate what is necessarily to be stored in memory. In an example, storing the match scores (or other correlation scores or data, such as pseudo distances) and/or relative coordinates between gallery images (e.g., 402, 404, 406, 408) can be sufficient.

In the conceptual illustration of FIG. 4, it may be appreciated that the gallery images 402 and 408 share very little overlap (e.g., spatial or conceptual) of the subject's biometric presentation (e.g., fingerprint(s)), where the overlap is indicated by the hashed area 410. Consequently, it is expected that the match score between the gallery image 402 (and/or corresponding metadata) and the gallery image 408 (and/or corresponding metadata) is relatively low. However, the gallery image 402 has decent overlap (e.g., spatial or conceptual) with the gallery image 404, which in turn has decent overlap (e.g., spatial or conceptual) with the gallery image 406, which in turn has decent overlap (e.g., spatial or conceptual) with the gallery image 408. As such, the gallery image 402 can be considered connected to the gallery image 408 through a series of additional gallery images (e.g., 404, 406, in this example) such that the match scores across adjacent gallery images (and/or corresponding metadata) extending from the gallery image 402 to the gallery image 408 does not fall below a certain threshold (e.g., MinMatchThreshold). On the other hand, consider a potential gallery image 412, illustrated in FIG. 4 in broken line. The match scores between the gallery image 412 (and/or corresponding metadata) and every other gallery image (and/or corresponding metadata) in the Gallery Set is relatively low, such as below a certain threshold (e.g., MinMatchThreshold). One option is to delete the gallery image 412, as for example, it may have low match scores also due to factors other than simply the gallery image's spatial or conceptual relationship to the other gallery images, such as image blur or other image quality issues. Another option is to use information relating to the gallery image 412 to try to collect additional enrollment images (as described above with respect to FIG. 3) to create a new portion of the Gallery Web 400 connecting image 412 to one or more other gallery images of the Gallery Web, similar to the way the gallery image 402 is connected to the gallery image 408 through the gallery images 404, 406. Yet another option is to retain the gallery image 412 and assign it a lower confidence score (discussed in further detail below) to generally represent it as being an outlier as compared to other gallery images in the Gallery Web 400.

For the sake of clarification, it is noted that FIG. 4 is simply a schematic and conceptual illustration of a Gallery Web 400. In practice, the Gallery Set includes data indicating the “web” correlation between the gallery images (e.g., 402, 404, 406, 408) and/or data from which the “web” correlation between the gallery images (e.g., 402, 404, 406, 408) can be determined. Any data structure for storing such data along with, or separate from, the gallery images may be used.

In an example, a confidence score may be assigned to each gallery image (and/or corresponding metadata) in the Gallery Set. In an example, a confidence score may be assigned to each gallery image (and/or corresponding metadata) based upon the similarity of its match score(s) to other “nearby” gallery images. For example, one method of determining a confidence score for a given gallery image includes summing or averaging the top M, for example three (but any suitable value may be used), match scores for the given image with respect to the other gallery images in the Gallery Set. The confidence score(s) may be used when performing a verification or identification with the particular Gallery Set (discussed in further detail below) to determine a weight for assigning a confidence in a particular match between a probe image and the particular Gallery Set. For example, the match score determined between a probe image and the particular Gallery Set during a verification or identification may be equal to a standard biometric match score, calculated using any suitable, conventional, or commercially available algorithm, multiplied by the confidence score to arrive at, for example, a net match score.

Although the flowchart of FIG. 3 illustrates an example method as comprising sequential steps or processes as having a particular order of operations, many of the steps or operations in the flowchart can be performed in parallel or concurrently, and the flowchart should be read in the context of the various embodiments of the present disclosure. The order of the method steps or process operations illustrated in FIG. 3 may be rearranged for some embodiments. Similarly, the method illustrated in FIG. 3 could have additional steps or operations not included therein or fewer steps or operations than those shown.

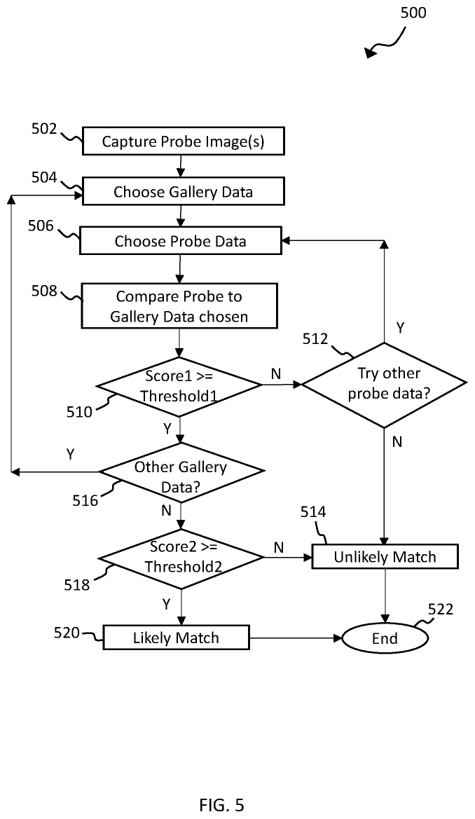

Various embodiments of the present disclosure are also generally directed to matching one or more probe images of a biometric presentation, such as a fingerprint, to a Gallery Set for the purposes of identification or verification of a subject. An example method 500 for matching one or more probe images of a biometric presentation to a Gallery Set or Gallery Web is illustrated in FIG. 5. While described primarily with respect to identification or verification of a subject based on fingerprint data, the same or similar method for identification or verification of a subject may additionally or alternatively be based on other biometric modalities, such as but not limited to, facial recognition data, iris data, palm print data, etc.

At step 502 of the method 500, one or more probe images of a biometric presentation, such as a fingerprint, are captured. The one or more probe images may be captured using, for example, a fingerprint scanning apparatus (e.g., 100) or any other suitable biometric scanning apparatus. The one or more probe images may be processed. As described above with respect to step 304 of the method 300, image processing may include performing one or more of a multitude of image processing algorithms, such as segmentation.

At step 504 of the method 500, a first set of gallery data from the Gallery Set or Gallery Web may be selected for which to compare the selected first probe image (and/or corresponding metadata). In an example, a first set of gallery data may be selected as a set of gallery images (and/or corresponding metadata) that includes a relatively high percentage, such as but not limited to more than 50%, more than 60%, more than 70%, more than 80%, more than 90%, or more than 95%, of the total information represented by the Gallery Set/Web, but that amongst or between the selected set of gallery images (and/or corresponding metadata) there is relatively low correlation, such as but not limited to, respective correlations (e.g., match scores) between the selected set of gallery images (and/or corresponding metadata) that are below a certain threshold. A value of the certain threshold may be reset or predefined, or, for example, may be dynamically determined based on the correlations (e.g., match scores) amongst or between all the images of the Gallery Set/Web.

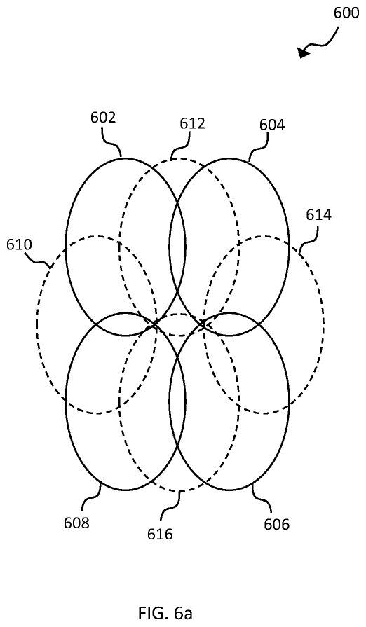

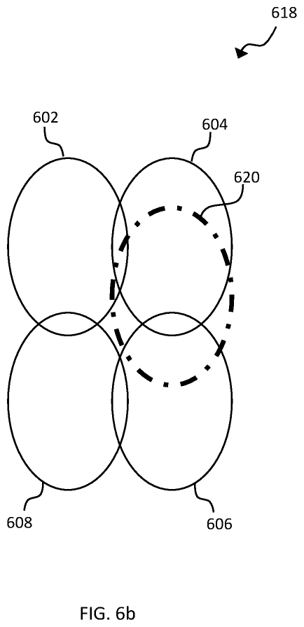

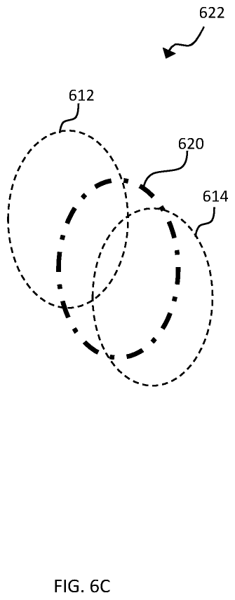

By way of example and not limitation, consider the Gallery Set schematically and conceptually illustrated as the Gallery Web 600 in FIG. 6a. The Gallery Web 600 was generated from biometric presentation images (and/or corresponding metadata) 602, 604, 606, 608, 610, 612, 614, 616 of the Gallery Set. The Gallery Web 600 may be generated in the same manner as the Gallery Web 400, described above. As described above, position and/or distance data or match/correlation scores amongst the gallery images 602, 604, 606, 608, 610, 612, 614, 616 (and/or corresponding metadata) may be determined and saved as part of, or as corresponding to, the Gallery Web 600. Example match scores (out of a max match score of 1.00) for the Gallery Web 600 are illustrated in Table 1. However, as noted above, instead of match scores, position and/or distance data or pseudo distances may be used. In the example Table 1, the higher the match score between two images (and/or corresponding metadata), the more closely correlated the two images (and/or corresponding metadata) are.

TABLE 1
Match Scores for Gallery Web 600 and Probe Image 620

| Image | 602 | 604 | 606 | 608 | 610 | 612 | 614 | 616 |
|---|---|---|---|---|---|---|---|---|
| 602 | | 0.10 | 0.00 | 0.10 | 0.40 | 0.40 | 0.00 | 0.00 |
| 604 | 0.10 | | 0.10 | 0.00 | 0.00 | 0.40 | 0.40 | 0.00 |
| 606 | 0.00 | 0.10 | | 0.10 | 0.00 | 0.00 | 0.40 | 0.40 |
| 608 | 0.10 | 0.00 | 0.10 | | 0.40 | 0.00 | 0.00 | 0.40 |
| 610 | 0.40 | 0.00 | 0.00 | 0.40 | | 0.10 | 0.00 | 0.10 |
| 612 | 0.40 | 0.40 | 0.00 | 0.00 | 0.10 | | 0.10 | 0.10 |
| 614 | 0.00 | 0.40 | 0.40 | 0.00 | 0.00 | 0.10 | | 0.10 |
| 616 | 0.00 | 0.00 | 0.40 | 0.40 | 0.10 | 0.10 | 0.10 | |
| Probe 620a | 0.05 | 0.55 | 0.20 | 0.00 | | | | |
| Probe 620b | | | | | | 0.40 | 0.60 | |

Considering the data in Table 1, a first set of gallery images (and/or corresponding metadata) may be selected that includes a relatively high percentage of the total information represented by the Gallery Set/Web 600, but that the selected set of gallery images (and/or corresponding metadata) itself, is fairly uncorrelated. A non-limiting example of a first set of gallery images (and/or corresponding metadata) 618 is schematically and conceptually illustrated in FIG. 6b. The first set of gallery images 618 (and/or corresponding metadata) includes images 602, 604, 606, and 608 (and/or corresponding metadata). From Table 1, it can be appreciated that the highest match score between any two of these images is 0.10. Thus, these images can be considered fairly uncorrelated to one another, yet as schematically and conceptually illustrated in FIG. 6a, these images 602, 604, 606, and 608 (and/or corresponding metadata) comprise a substantial portion of the total information represented by the Gallery Set/Web 600. Determining whether a selected set of images comprises a relatively high percentage or substantial portion of the total information represented by the Gallery Set/Web may be based on spatial/location information, distance information, and/or the match scores (or other correlation scores or data) determined or saved for the gallery images.

Referencing back to FIG. 5, at step 506 of the method 500, a first probe image (and/or corresponding metadata) is selected from the one or more probe images. The first probe image (and/or corresponding metadata) may be selected based on any suitable algorithm or method, including randomly or semi-randomly, and may be selected for any reason or based on any factor(s) or characteristic(s). In an example, the first probe image (and/or corresponding metadata) may be selected based on a quality metric of the one or more probe images, such as but not limited to, whether the appropriate biometric or biometrics are presented and/or whether image contrast and/or resolution are sufficient. In a further example, the first probe image (and/or corresponding metadata) may be selected as the first one of several probe images in a sequence of images captured for a biometric presentation (e.g., the one or more probe images captured at step 502) that meets a certain (e.g., predefined or preset) quality metric. In another example, one or more probe images (and/or corresponding metadata) captured at step 502 meeting, for example, a certain (e.g., predefined or preset) quality metric may be stored as part of a Probe Set. The first probe image (and/or corresponding metadata) may be selected from this Probe Set. In an example, the probe images (and/or corresponding metadata) of the Probe Set may be matched against one another, and the first probe image may be selected as the probe image with a highest number of matches (e.g., match scores) above a certain (e.g., predefined or preset) threshold. This might be considered as representing the most common view or orientation of the biometric presentation that the subject provided. In another example, a Probe Web may be generated from the Probe Set in the same manner as a Gallery Web may be generated from the Gallery Set, as described above. The first probe image (and/or corresponding metadata) may be selected from a given sector of the Probe Web. In some examples, the first probe image (and/or corresponding metadata) may be selected from a middle or near middle sector of the Probe Web.

At step 508 of the method 500, the first probe image (and/or corresponding metadata) selected at step 506 is matched or compared against the first set of gallery data selected at step 504. In an example, the first probe image (and/or corresponding metadata) is matched or compared against each of the gallery images (and/or corresponding metadata) comprising the first set of gallery data to generate a set of corresponding match scores. A gallery data match score, GalleryScore1, may be determined based on the resulting set of match scores. In an example, the GalleryScore1 may be the highest score of the resulting set of match scores. In another example, the GalleryScore1 may be the total of the resulting set of match scores or the average of the resulting set of match scores. However, any method for determining the GalleryScore1 based on the resulting set of match scores may be used.

By way of example, with reference to the first set of gallery images 618 (and/or corresponding metadata) illustrated in FIG. 6b, matching a first probe image 620 (and/or corresponding metadata) with each of the gallery images 602, 604, 606, and 608 (and/or corresponding metadata) results in the corresponding match scores shown in the row of Table 1, above, marked Probe 620a. As can be appreciated, the highest match score of 0.55 resulted from a comparison of the probe image 620 (and/or corresponding metadata) with the gallery image 604 (and/or corresponding metadata). In an example, this score (e.g., 0.55) may be used as the gallery data match score (e.g., GalleryScore1).

At step 510 of the method 500, the GalleryScore1 generated at step 508 is compared to a certain (e.g., predefined or preset) threshold, Threshold1. In general, at this step, the method is checking to determine whether there is a possibility of a genuine match between the first probe image and the Gallery Set. If GalleryScore1 is less than the Threshold1, then the method may be provided with an option at step 512 to try another of the probe images. If the method 500 determines at step 512 to try another probe image, then the method returns to step 506 at which another probe image (and/or corresponding metadata) is selected from the one or more probe images and steps 508 and 510 may be repeated with the newly selected probe image. The loop of the steps 506, 508, 510, and 512 may be repeated for any number of selected probe images. In an example, the loop may be repeated for a number of selected probe images until a GalleryScore1 is equal to or greater than the Threshold1. In an example, the loop may be repeated for a number of selected probe images until the method determines at step 512 not to try another probe image or there are no further probe images to try. If all the GalleryScore1 scores determined during the loop of the steps 506, 508, 510, and 512 are less than Threshold1, then it is highly unlikely that there is a match between the biometric presentation and the Gallery Set. Thus, when the method determines at step 512 not try another probe image or there are no further probe images to try, the method 500 may proceed to optional step 514 to report that a match between the biometric presentation and the Gallery Set is unlikely and to step 522 where the method ends.

If at step 510, one or more of the GalleryScore1 scores are greater than the Threshold1, then at step 516 the method 500 may determine to test other gallery data from the Gallery Set. If the method 500 determines to test other gallery data, the method proceeds back to step 504 where a next set of gallery data from the Gallery Set is selected. In an example, the next set of gallery data may be selected based on the prior matching of one or more probe images at step 508 against the current set of gallery data (e.g., the first set of gallery data). For instance, in an example, the next set of gallery data selected may be based upon the nearest neighbors of one or more of the gallery images (and/or corresponding metadata) of the current set of gallery data (e.g., the first set of gallery data) having the highest matching score(s) with the one or more probe images compared at step 508. After the next set of gallery data is selected, the method 500 may loop through steps 506, 508, 510, 512, and 516 in the same manner as described above with respect to the first set of gallery data, but using the next selected set of gallery data.

By way of example, with reference again to the Gallery Set/Web 600 and Table 1, as noted above, the highest match score of 0.55 resulted from a comparison of the probe image 620 (and/or corresponding metadata) with the gallery image 604 (and/or corresponding metadata). As can be appreciated from Table 1 and as illustrated in FIG. 6a, the gallery images 612 and 614 (and/or corresponding metadata) have the highest correlation (e.g., match scores of 0.4) with the gallery image 604 (and/or corresponding metadata), and thus may be considered the nearest neighbors of the gallery image 604. Accordingly, the next selected set of gallery data in this example may comprise the set of gallery images 612 and 614 (and/or corresponding metadata). An example of this set of gallery images 622 (and/or corresponding metadata) is schematically and conceptually illustrated in FIG. 6c. Looping back through step 508 of the method 500 to match the first probe image 620 (and/or corresponding metadata) with each of the gallery images 612 and 614 (and/or corresponding metadata) results in the corresponding match scores shown in the row of Table 1, above, marked Probe 620b. As can be appreciated, the new highest match score of 0.60 resulted from a comparison of the probe image 620 (and/or corresponding metadata) with the gallery image 614 (and/or corresponding metadata).

With reference back to the method 500, if at step 516, there is no other gallery data to be selected or the system determines not to test further gallery data from the Gallery Set, the method 500 proceeds to step 518 where a gallery match score, GalleryScore2, may be determined and compared to a certain (e.g., predefined or preset) threshold, Threshold2. The GalleryScore2 may be a fusion of match scores. For example, the GalleryScore2 may be based on, or determined from (e.g., by mathematical combination), a plurality of the GalleryScore1 scores determined at step 508. In another example, the GalleryScore2 may be based on, or determined from, one or more match scores between one or more of the probe images (and/or corresponding metadata) selected at step 506 and one or more of the gallery images (and/or corresponding metadata) of the Gallery Set. A non-limiting example equation for determining the GalleryScore2 can be defined as Equation (2) below:

$$GalleryScore 2 = {PG}_{1} + \frac{{a}_{2} \cdot {PG}_{2}}{{G}_{2} {G}_{1} + {b}_{2}} + \frac{{a}_{3} \cdot {PG}_{3}}{{G}_{3} {G}_{1} + {G}_{3} {G}_{2} + {b}_{3}} + \frac{{a}_{4} \cdot {PG}_{4}}{{G}_{4} {G}_{1} + {G}_{4} {G}_{2} + {G}_{4} {G}_{3} + {b}_{4}} + ⋯ , \qquad ( 2 )$$

where PGₙ is the match score between a probe image (and/or corresponding metadata) and the nth image of the Gallery Set, GₙGₘ is the match score between the n^{th} image and m^{th} image of the Gallery Set, and aₙ and bₙ are optional scaling parameters to control the weighting of additional terms in the score. In this regard, the GalleryScore2 may weight probe-gallery matches based upon how correlated the gallery images are to one another. For example, if gallery image 2 is weakly correlated with gallery image 1, then G₂G₁ will be low, thereby increasing the value of the fraction shown as the second term in Equation (2). A value b₂ may be added to ensure that low correlation values GₘGₙ that could be near zero do not result in extremely large fraction values. On the other hand, if gallery image 2 is strongly correlated with gallery image 1, then GₘGₙ will be high, thereby decreasing the value of the fraction shown as the second term in Equation (2). A value aₙ may be added to scale the gallery-to-gallery match scores to control the contribution of the additional terms. Further, although Equation (2) shows the GalleryScore2 being determined based on an indefinite number of terms, a finite number of terms could be used. To facilitate such an example, the first gallery image (i.e., G₁) may desirably be the gallery image that has the highest match score with the probe image (i.e., P). Moreover, the second gallery image (i.e., G₂) may desirably be the gallery image that has the second highest match score with the probe image, the third gallery image (i.e., G₃) may desirably be the gallery image that has the third highest match score with the probe image, and so on until the desired finite number of terms is reached. Additionally or alternatively, there may be a dynamic cutoff for additional terms. For example, if a match score PGₙ is less than a certain (e.g., predefined or preset) threshold, then the term comprising that match score PGₙ may be excluded from Equation (2). While an example equation for determining the GalleryScore2 is described above, other suitable fusions or mathematical combinations of scores described herein may be used to generate the GalleryScore2.

If at step 518, the GalleryScore2 is determined to be less than the Threshold2, the method 500 may proceed to optional step 514 to report that a match between the biometric presentation and the Gallery Set is unlikely and to step 522 where the method ends. If at step 518, the GalleryScore2 is determined to be equal to or greater than the Threshold2, the method 500 may proceed to optional step 520 to report that a match between the biometric presentation and the Gallery Set is likely and to step 522 where the method ends.

Although the flowchart of FIG. 5 illustrates an example method as comprising sequential steps or processes as having a particular order of operations, many of the steps or operations in the flowchart can be performed in parallel or concurrently, and the flowchart should be read in the context of the various embodiments of the present disclosure. The order of the method steps or process operations illustrated in FIG. 5 may be rearranged for some embodiments. Similarly, the method illustrated in FIG. 5 could have additional steps or operations not included therein or fewer steps or operations than those shown.

Additionally, the flowchart of FIG. 5 may be part of a larger process flow. For example, upon reaching step 522, the process may proceed to matching the one or more probe images of a biometric presentation to another Gallery Set or Gallery Web (e.g., in the case of one-to-many, or 1:N, matching). In another example, the process may prompt the subject to re-scan their biometric presentation or may move on to another form of verification or identification, such as passcode entry or presentation of an RFID (radio frequency identification) card.

While the foregoing method is described in the context of matching one or more probe images of a biometric presentation to a Gallery Set or Gallery Web, a generally flipped method of matching one or more gallery images to a Probe Set or Probe Web of probe images of a biometric presentation is also within the scope of the present disclosure. For example, at step 502, a Probe Set or Probe Web may be determined based on the probe images captured. Then, the method may proceed through the rest of the method 500, but with the roles of the probe data/images and gallery data/images reversed.

The various embodiments of the present disclosure involve matching or comparing images. For the sake of clarity, while the term “images” is used in this context for ease of explanation, it is understand that the term “images,” as used herein and in the claims, can include images/image data and/or other data or metadata corresponding to or derived from image data (e.g., biometric template data, minutia point locations and angles of a fingerprint, or landmark point locations of a face). Thus, any such matching or comparing of “images” described herein may include a direct matching or comparison of images or image data, a matching or comparison of data or metadata corresponding to or derived from image data (e.g., biometric template data, minutia point locations and angles of a fingerprint, or landmark point locations of a face), or any combination of the foregoing.

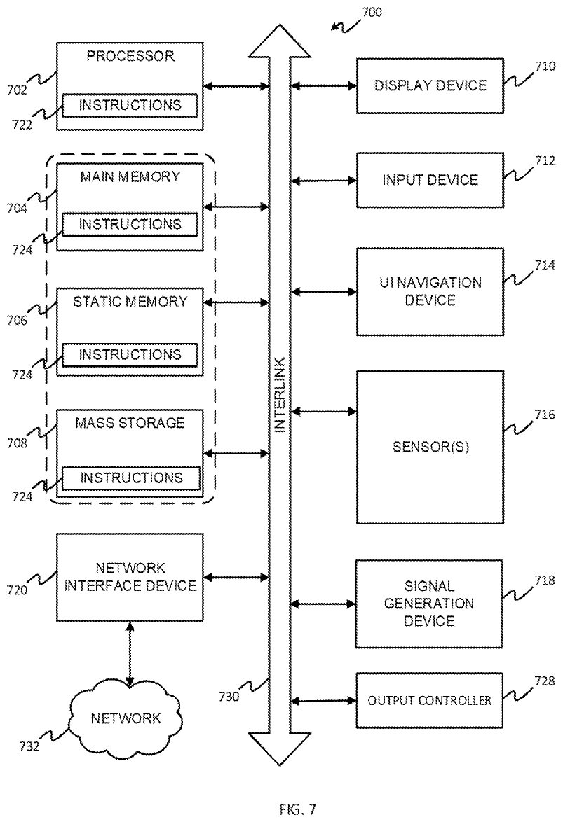

FIG. 7 illustrates a block diagram schematic of various example components 700 that can may be included as part of, or may be operably connected to, for example, a biometric scanning apparatus (e.g., 100) or processing device 104 for carrying out any of functionality or methods described herein. In some embodiments, the components 700 can operate as a part of a standalone device or one or more components can be remotely located and communicatively connected to one another, for example, via a network.

The components 700 can include a hardware processor 702 (e.g., a central processing unit (CPU), a graphics processing unit (GPU), a hardware processor core, or any combination thereof) and a main memory 704, a static memory (e.g., memory or storage for firmware, microcode, a basic-input-output (BIOS), unified extensible firmware interface (UEFI), etc.) 706, and/or mass storage 708 (e.g., hard drives, tape drives, flash storage, or other block devices) some or all of which can communicate with each other via an interlink (e.g., bus) 730. The components 700 can further include a display device 710 and an input device 712 and/or a user interface (UI) navigation device 714. Example input devices and UI navigation devices include, without limitation, one or more buttons, a keyboard, a touch-sensitive surface, a stylus, a camera, a microphone, etc.). In some examples, one or more of the display device 710, input device 712, and UI navigation device 714 can be a combined unit, such as a touch screen display. The components 700 can additionally include a signal generation device 718 (e.g., a speaker), a network interface device 720, and one or more sensors 716, such as a global positioning system (GPS) sensor, compass, accelerometer, or other sensor. The components 700 can include an output controller 728, such as a serial (e.g., universal serial bus (USB), parallel, or other wired or wireless (e.g., infrared (IR), NFC, etc.) connection to communicate or control one or more peripheral devices (e.g., a printer, card reader, etc.).

The processor 702 can correspond to one or more computer processing devices or resources. For instance, the processor 702 can be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 702 can be provided as a microprocessor, Central Processing Unit (CPU), or plurality of microprocessors or CPUs that are configured to execute instructions sets stored in an internal memory 722 and/or the memory 704, 706, 708.

Any of the memory 704, 706, and 708 can be used in connection with the execution of application programming or instructions by the processor 702 for performing any of the functionality or methods described herein, and for the temporary or long-term storage of program instructions or instruction sets 724 and/or other data for performing any of the functionality or methods described herein. Any of the memory 404, 406, 408 can comprise a computer readable medium that can be any medium that can contain, store, communicate, or transport data, program code, or the instructions 724 for use by or in connection with the components 700. The computer readable medium can be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or EEPROM), Dynamic RAM (DRAM), a solid-state storage device, in general, a compact disc read-only memory (CD-ROM), or other optical or magnetic storage device. As noted above, computer-readable media includes, but is not to be confused with, computer-readable storage medium, which is intended to cover all physical, non-transitory, or similar embodiments of computer-readable media.

The network interface device 720 includes hardware to facilitate communications with other devices over a communication network, such as a network 732, utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., networks based on the IEEE 802.11 family of standards known as Wi-Fi or the IEEE 802.16 family of standards known as WiMax), networks based on the IEEE 802.15.4 family of standards, and peer-to-peer (P2P) networks, among others. In some examples, the network interface device 720 can include an Ethernet port or other physical jack, a Wi-Fi card, a Network Interface Card (NIC), a cellular interface (e.g., antenna, filters, and associated circuitry), or the like. In some examples, the network interface device 720 can include one or more antennas to wirelessly communicate using at least one of single-input multiple-output (SIMO), multiple-input multiple-output (MIMO), or multiple-input single-output (MISO) techniques.

As indicated above, the components 700 can include one or more interlinks or buses 730 operable to transmit communications between the various components 700. A system bus 730 can be any of several types of commercially available bus structures or bus architectures.

There are several advantages of the various embodiments of the present disclosure. These include, but are not limited to: lower failure to acquire rates; and higher genuine match rates, and thus, lower false rejection rates (FRR) for a given false acceptance rate (FAR).

### Additional Examples

Example 1 includes subject matter relating to a method for enrollment of a biometric presentation for a biometric security system, the method comprising: capturing and processing a plurality of images of the biometric presentation to produce a plurality of candidate images; forming, and storing in memory of the biometric security system, a Gallery Set of gallery images from at least some of the plurality of candidate images based on a matching of the plurality of candidate images; and generating, and storing in the memory of the biometric security system, a Gallery Web from the Gallery Set, the Gallery Web comprising correlation data defining correlations between the gallery images of the Gallery Set.

In Example 2, the subject matter of Example 1 optionally includes wherein forming the Gallery Set from at least some of the plurality of candidate images based on a matching of the plurality of candidate images comprises, for each given candidate image of at least a subset of the plurality of candidate images, determining whether to add the given candidate image to the Gallery Set based on a comparison of the given candidate image with each of one or more gallery images of the Gallery Set.

In Example 3, the subject matter of Example 2 optionally includes wherein the comparison of the given candidate image with each of the one or more gallery images of the Gallery Set comprises matching the given candidate image with each of the one or more gallery images of the Gallery Set to generate one or more respective match scores.

In Example 4, the subject matter of Example 3 optionally includes adding the given candidate image to the Gallery Set where the one or more match scores are each less than or equal to a maximum match threshold.

In Example 5, the subject matter of Example 4 optionally includes determining whether to replace a given gallery image with the given candidate image where a match score between the given candidate image and the given gallery image is greater than the maximum match threshold.

In Example 6, the subject matter of any of Examples 1 to 5 optionally includes wherein the correlation data comprises positional information for each of the gallery images, the positional information for a given gallery image corresponding to a spatial region of the biometric presentation to which the given gallery image pertains.

In Example 7, the subject matter of any of Examples 1 to 5 optionally includes wherein generating the Gallery Web from the Gallery Set comprises comparing each of the gallery images with one another to generate respective match scores.

In Example 8, the subject matter of Example 7 optionally includes wherein the correlation data comprises at least one of: the match scores or data derived from the match scores.

In Example 9, the subject matter of any of Examples 1 to 8 optionally includes wherein each of the candidate images comprises at least one of image data or metadata corresponding to a respective one of the plurality of images of the biometric presentation captured.

In Example 10, the subject matter of Example 9 optionally includes wherein each of the candidate images comprises biometric template data corresponding to a respective one of the plurality of images of the biometric presentation captured.

In Example 11, the subject matter of any of Examples 1 to 10 optionally includes wherein each of the gallery images comprises at least one of image data or metadata corresponding to a respective one of the plurality of images of the biometric presentation captured.

In Example 12, the subject matter of Example 11 optionally includes wherein each of the gallery images comprises biometric template data corresponding to a respective one of the plurality of images of the biometric presentation captured.

Example 13 includes subject matter relating to a method for identification and/or verification of a probe biometric presentation based on an enrolled biometric presentation, the method comprising: capturing and processing one or more images of the probe biometric presentation to produce one or more probe images including at least a first probe image; comparing the first probe image to a first subset of gallery images from a Gallery Set of gallery images corresponding to the enrolled biometric presentation, the first subset of gallery images determined based on correlation data defining correlations between the gallery images of the Gallery Set; determining a first gallery score based on the comparison of the first probe image to the first subset of gallery images; and at least one of identifying the probe biometric presentation, verifying the probe biometric presentation, or denying the probe biometric presentation based at least in part on the first gallery score.

In Example 14, the subject matter of Example 13 optionally includes wherein when the first gallery score is less than a first threshold, further comprising: comparing a second probe image from the one or more probe images to the first subset of gallery images; and determining a second gallery score based on the comparison of the second probe image to the first subset of gallery images.

In Example 15, the subject matter of Example 14 optionally includes at least one of identifying the probe biometric presentation, verifying the probe biometric presentation, or denying the probe biometric presentation based at least in part on the second gallery score.

In Example 16, the subject matter of Example 13 optionally includes comparing the first probe image to a second subset of gallery images from the Gallery Set, the second subset of gallery images determined based on the correlation data.

In Example 17, the subject matter of Example 16 optionally includes determining a second gallery score based on the comparison of the first probe image to the second subset of gallery images; and at least one of identifying the probe biometric presentation, verifying the probe biometric presentation, or denying the probe biometric presentation based at least in part on the first and second gallery scores.

In Example 18, the subject matter of Example 17 optionally includes wherein when the second gallery score is less than a first threshold, further comprising: comparing a second probe image from the one or more probe images to the second subset of gallery images; and determining a third gallery score based on the comparison of the second probe image to the second subset of gallery images.

In Example 19, the subject matter of Example 18 optionally includes at least one of identifying the probe biometric presentation, verifying the probe biometric presentation, or denying the probe biometric presentation based at least in part on the third gallery score.

In Example 20, the subject matter of any of Examples 13 to 19 optionally includes wherein each of the probe images comprises at least one of image data or metadata corresponding to a respective one of the one or more images of the probe biometric presentation captured.

In Example 21, the subject matter of Example 20 optionally includes wherein each of the probe images comprises biometric template data corresponding to a respective one of the one or more images of the probe biometric presentation captured.

In Example 22, the subject matter of any of Examples 13 to 21 optionally includes wherein each of the gallery images comprises at least one of image data or metadata corresponding to the enrolled biometric presentation.

In Example 23, the subject matter of Example 22 optionally includes wherein each of the gallery images comprises biometric template data corresponding to the enrolled biometric presentation.

Example 24 includes subject matter relating to a computer readable storage medium comprising executable code, that when executed by one or more processors, causes the one or more processors to: capture and process a plurality of images of the biometric presentation to produce a plurality of candidate images; form a Gallery Set of gallery images from at least some of the plurality of candidate images based on a matching of the plurality of candidate images; and generate a Gallery Web from the Gallery Set, the Gallery Web comprising correlation data defining correlations between the gallery images of the Gallery Set.

Example 25 includes subject matter relating to a biometric scanning apparatus comprising: a camera module configured to capture images of biometric presentations; one or more processors; and a computer readable storage medium comprising executable code, that when executed by the one or more processors, causes the one or more processors to: capture and process a plurality of images of a first biometric presentation to produce a plurality of candidate images; form a Gallery Set of gallery images from at least some of the plurality of candidate images based on a matching of the plurality of candidate images; and generate a Gallery Web from the Gallery Set, the Gallery Web comprising correlation data defining correlations between the gallery images of the Gallery Set.

Example 26 includes subject matter relating to a computer readable storage medium comprising executable code, that when executed by one or more processors, causes the one or more processors to: capture and process one or more images of a probe biometric presentation to produce one or more probe images including at least a first probe image; compare the first probe image to a first subset of gallery images from a Gallery Set of gallery images corresponding to an enrolled biometric presentation, the first subset of gallery images determined based on correlation data defining correlations between the gallery images of the Gallery Set; determine a first gallery score based on the comparison of the first probe image to the first subset of gallery images; and at least one of identify the probe biometric presentation, verify the probe biometric presentation, or deny the probe biometric presentation based at least in part on the first gallery score.

Example 27 includes subject matter relating to a biometric scanning apparatus comprising: a camera module configured to capture images of biometric presentations; one or more processors; and a computer readable storage medium comprising executable code, that when executed by the one or more processors, causes the one or more processors to: capture and process one or more images of a probe biometric presentation to produce one or more probe images including at least a first probe image; compare the first probe image to a first subset of gallery images from a Gallery Set of gallery images corresponding to an enrolled biometric presentation, the first subset of gallery images determined based on correlation data defining correlations between the gallery images of the Gallery Set; determine a first gallery score based on the comparison of the first probe image to the first subset of gallery images; and at least one of identify the probe biometric presentation, verify the probe biometric presentation, or deny the probe biometric presentation based at least in part on the first gallery score.

### Additional Notes

The above detailed description includes references to the accompanying drawings, which form a part of the detailed description. The drawings show, by way of illustration, specific embodiments that can be practiced. These embodiments may also be referred to herein as “examples.” Such embodiments or examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein. That is, the above-described embodiments or examples or one or more aspects, features, or elements thereof can be used in combination with each other.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

1. A method for enrollment of a biometric presentation for a biometric security system, the method comprising:
capturing and processing a plurality of images of the biometric presentation to produce a plurality of candidate images;
forming, and storing in memory of the biometric security system, a Gallery Set of gallery images from at least some of the plurality of candidate images based on a matching of the plurality of candidate images; and
generating, and storing in the memory of the biometric security system, a Gallery Web from the Gallery Set, the Gallery Web comprising correlation data defining correlations between the gallery images of the Gallery Set.

2. The method of claim 1, wherein forming the Gallery Set from at least some of the plurality of candidate images based on a matching of the plurality of candidate images comprises, for each given candidate image of at least a subset of the plurality of candidate images, determining whether to add the given candidate image to the Gallery Set based on a comparison of the given candidate image with each of one or more gallery images of the Gallery Set.

3. The method of claim 2, wherein the comparison of the given candidate image with each of the one or more gallery images of the Gallery Set comprises matching the given candidate image with each of the one or more gallery images of the Gallery Set to generate one or more respective match scores.

4. The method of claim 3, comprising adding the given candidate image to the Gallery Set where the one or more match scores are each less than or equal to a maximum match threshold.

5. The method of claim 4, comprising determining whether to replace a given gallery image with the given candidate image where a match score between the given candidate image and the given gallery image is greater than the maximum match threshold.

6. The method of claim 1, wherein the correlation data comprises positional information for each of the gallery images, the positional information for a given gallery image corresponding to a spatial region of the biometric presentation to which the given gallery image pertains.

7. The method of claim 1, wherein generating the Gallery Web from the Gallery Set comprises comparing each of the gallery images with one another to generate respective match scores.

8. The method of claim 7, wherein the correlation data comprises at least one of: the match scores or data derived from the match scores.

9. The method of claim 1, wherein each of the candidate images comprises at least one of image data or metadata corresponding to a respective one of the plurality of images of the biometric presentation captured.

10. The method of claim 9, wherein each of the candidate images comprises biometric template data corresponding to a respective one of the plurality of images of the biometric presentation captured.

11. The method of claim 1, wherein each of the gallery images comprises at least one of image data or metadata corresponding to a respective one of the plurality of images of the biometric presentation captured.

12. The method of claim 11, wherein each of the gallery images comprises biometric template data corresponding to a respective one of the plurality of images of the biometric presentation captured.

13-23. (canceled)

24. A computer readable storage medium comprising executable code, that when executed by one or more processors, causes the one or more processors to:
capture and process a plurality of images of the biometric presentation to produce a plurality of candidate images;
form a Gallery Set of gallery images from at least some of the plurality of candidate images based on a matching of the plurality of candidate images; and
generate a Gallery Web from the Gallery Set, the Gallery Web comprising correlation data defining correlations between the gallery images of the Gallery Set.

25. A biometric scanning apparatus comprising:
a camera module configured to capture images of biometric presentations;
one or more processors; and
a computer readable storage medium comprising executable code, that when executed by the one or more processors, causes the one or more processors to:
capture and process a plurality of images of a first biometric presentation to produce a plurality of candidate images;
form a Gallery Set of gallery images from at least some of the plurality of candidate images based on a matching of the plurality of candidate images; and
generate a Gallery Web from the Gallery Set, the Gallery Web comprising correlation data defining correlations between the gallery images of the Gallery Set.

26-27. (canceled)
